(19) United States
(12) Patent Application Publication
(10) Pub. No.: US 2023/0179075 A1
(43) Pub. Date: Jun. 8, 2023

(54) CURRENT DETECTION CIRCUIT, DC/DC CONVERTER, AND ELECTRIC APPARATUS

(71) Applicant: ROHM CO., LTD., Kyoto (JP)

(72) Inventors: Akira URYU, Kyoto (JP); Tadayuki SAKAMOTO, Kyoto (JP); Osamu YANAGIDA, Kyoto (JP)

(21) Appl. No.: 18/073,989

(22) Filed: Dec. 2, 2022

(30) Foreign Application Priority Data
Dec. 2, 2021 (JP) 2021-196288

(51) Int. Cl. H02M 1/00; H02M 3/158

(52) U.S. Cl. CPC H02M 1/0009; H02M 3/158

(57) ABSTRACT

A current detection circuit includes: at least one current detector configured to detect a current flowing through a second switch element of at least one switching output stage configured to connect a first switch element and the second switch element in series; an analog signal generator configured to generate an analog signal corresponding to the current detected by the at least one current detector; a converter configured to receive the analog signal, convert the analog signal to a digital signal corresponding to an integrated value of the analog signal, and output the digital signal; and a corrector configured to correct any one of a drive voltage, an input, and an output of the converter according to an on-DUTY of the second switch element.

### CROSS-REFERENCE TO RELATED APPLICATION

This application is based upon and claims the benefit of priority under 35 U.S.C. § 119 to Japanese Patent Application No. 2021-196288, filed on Dec. 2, 2021, the entire contents of which is incorporated herein by reference.

### TECHNICAL FIELD

The present disclosure relates to a current detection circuit installed in a DC/DC converter.

### BACKGROUND

In a DC/DC converter, a current detection circuit is installed to control a switch element of a switching output stage or for use when performing an overcurrent protection based on a detected current. There are various detection techniques used in the current detection circuit.

A current detection circuit may be installed for each of an upper switch element and a lower switch element of a switching output stage to detect a current flowing through the upper switch element and a current flowing through the lower switch element, which may result in an increase in costs.

When a technique of detecting a current at the middle point of a section in which the upper switch element or the lower switch element is turned on is used, providing a current detection circuit for each of the upper switch element and the lower switch element becomes unnecessary but controlling a timing of current detection may be difficult and a current detection accuracy may deteriorate.

### SUMMARY

According to an embodiment of the present disclosure, there is provided a current detection circuit, which includes: at least one current detector configured to detect a current flowing through a second switch element of at least one switching output stage configured to connect a first switch element and the second switch element in series; an analog signal generator configured to generate an analog signal corresponding to the current detected by the at least one current detector; a converter configured to receive the analog signal, convert the analog signal to a digital signal corresponding to an integrated value of the analog signal, and output the digital signal; and a corrector configured to correct any one of a drive voltage, an input, and an output of the converter according to an on-DUTY of the second switch element.

According to another embodiment of the present disclosure, there is provided a DC/DC converter, which includes: the current detection circuit of the above-described feature; the at least one switching output stage configured to connect the first switch element and the second switch element in series; and a control circuit configured to control switching of the first switch element and the second switch element.

According to another embodiment of the present disclosure, there is provided an electric apparatus, which includes the DC/DC converter of the aforementioned feature.

### BRIEF DESCRIPTION OF DRAWINGS

The accompanying drawings, which are incorporated in and constitute a part of the specification, illustrate embodiments of the present disclosure.

FIG. 1 is a diagram showing an overall structure of a DC/DC converter according to a first embodiment of the present disclosure.

FIG. 2 is a diagram showing a structure of a current detection circuit according to the first embodiment.

FIG. 3 is a diagram showing an integration period of an integrated value of an analog signal according to the first embodiment.

FIG. 4 is a diagram showing an overall structure of a DC/DC converter according to a second embodiment of the present disclosure.

FIG. 5 is a diagram showing a first structure example of a current detection circuit according to the second embodiment.

FIG. 6 is a diagram showing an integration period of an integrated value of an analog signal.

FIG. 7 is a diagram showing details of the first structure example of the current detection circuit according to the second embodiment.

FIG. 8 is a diagram showing an integration period of an integrated value of an analog signal when a mask period is set.

FIG. 9 is a diagram showing a second structure example of the current detection circuit according to the second embodiment.

FIG. 10 is a diagram showing a third structure example of the current detection circuit according to the second embodiment.

FIG. 11 is a diagram showing an overall structure of a DC/DC converter according to a third embodiment of the present disclosure.

FIG. 12 is a diagram showing a structure of a current detection circuit according to the third embodiment.

FIG. 13 is an external view of an electric apparatus.

### DETAILED DESCRIPTION

### First Embodiment

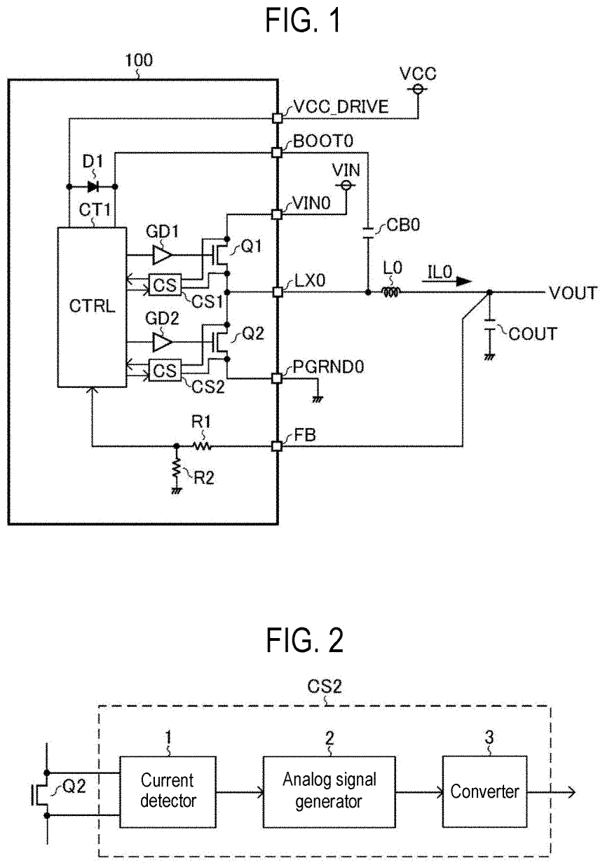

FIG. 1 is a diagram showing an overall structure of a DC/DC converter according to a first embodiment of the present disclosure. The DC/DC converter according to the present embodiment includes a semiconductor device 100, an inductor L0, a bootstrap capacitor CB0, and an output capacitor COUT.

The DC/DC converter according to the present embodiment steps down a DC input voltage VIN to generate an output voltage VOUT.

The semiconductor device 100 includes a terminal VCC_DRIVE, a terminal VIN0, and a terminal LX0. The semiconductor device 100 receives a DC input voltage VCC at the terminal VCC_DRIVE, receives the DC input voltage VIN at the terminal VIN0, and outputs a switch voltage from the output terminal LX0. The switch voltage output from the output terminal LX0 is converted to the output voltage VOUT by the inductor L0 and the output capacitor COUT. The output voltage VOUT is supplied to a load (not shown) connected to a connection node between the inductor L0 and the output capacitor COUT.

The semiconductor device 100 further includes a terminal BOOT0, a terminal PGRND0, and a terminal FB. A first end of the bootstrap capacitor CB0 is connected to the terminal BOOT0. A second end of the bootstrap capacitor CB0 is connected to a connection node between the terminal LX0 and the inductor L0. The terminal PGRND0 is connected to a ground potential. The terminal FB is connected to the connection node between the inductor L0 and the output capacitor COUT.

The semiconductor device 100 further includes a first switch element Q1, a second switch element Q2, a control circuit CT1, a driver GD1, a driver GD2, a current detection circuit CS1, a current detection circuit CS2, resistors R1 and R2, and a diode D1.

In the present embodiment, each of the first switch element Q1 and the second switch element Q2 includes an NMOS transistor. A drain of the first switch element Q1 is connected to the terminal VIN0, a source of the first switch element Q1 and a drain of the second switch element Q2 are connected to the terminal LX0, and a source of the second switch element Q2 is connected to the terminal PGRND0. When the NMOS transistor is used in the first switch element Q1 as in the present embodiment, a bootstrap circuit including the terminal VCC_DRIVE, the diode D1, and the bootstrap capacitor CB0 is used. The bootstrap circuit may generate a high voltage that may reliably turn on the first switch element Q1.

The control circuit CT1 controls switching of the first switch element Q1 and the second switch element Q2 according to a value of the output voltage VOUT. The driver GD1 receives a control signal from the control circuit CT1 and applies a voltage to a gate of the first switch element Q1. The driver GD2 receives a control signal from the control circuit CT1 and applies a voltage to a gate of the second switch element Q2. The current detection circuit CS1 detects a current flowing through the first switch element Q1. The current detection circuit CS2 detects a current flowing through the second switch element Q2. The resistors R1 and R2 supply a partial voltage of the output voltage VOUT to the control circuit CT1.

FIG. 2 is a diagram showing a structure example of the current detection circuit CS2. The current detection circuit CS2 of the structure example shown in FIG. 2 includes a current detector 1, an analog signal generator 2, and a converter 3. The current detector 1 detects a current flowing between the source and the drain of the second switch element. The analog signal generator 2 generates an analog signal corresponding to the current detected by the current detector 1. The converter 3 converts an integrated value of the analog signal generated by the analog signal generator 2 to a digital signal.

The current detection circuit CS1 that detects the current flowing through the first switch element Q1 and the current detection circuit CS2 that detects the current flowing through the second switch element Q2 have the same structure. However, the current detection circuit CS2 includes low-voltage elements, whereas the current detection circuit CS1 includes high-breakdown-voltage elements.

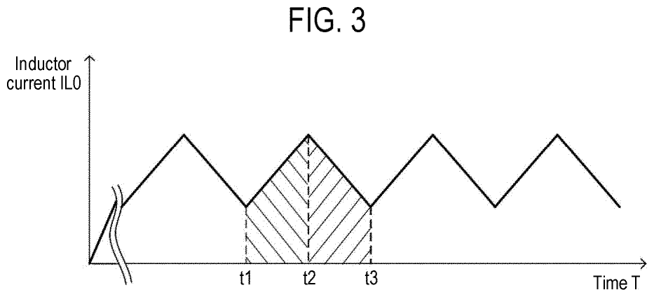

FIG. 3 is a diagram showing an integration period of the integrated value of the analog signal. The first switch element Q1 is turned on during a period from t1 to t2. During this period, a current is detected by the current detection circuit CS1. The second switch element Q2 is turned on during a period from t2 to t3. During this period, a current is detected by the current detection circuit CS2. By using a method of converting the integrated value of the analog signal in a period from t1 to t3 to a digital signal, as compared with a method of detecting a current at the middle point of a section in which the first switch element Q1 or the second switch element Q2 is turned on, it becomes easier to control a timing of current detection, thereby improving the accuracy of current detection.

### Second Embodiment

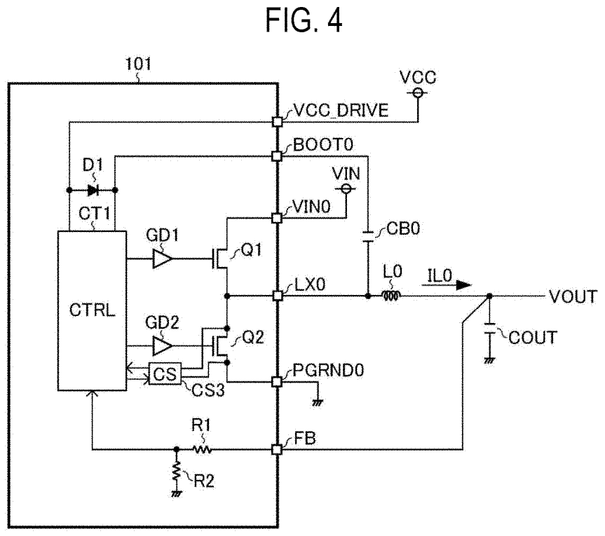

FIG. 4 is a diagram showing an overall structure of a DC/DC converter according to a second embodiment of the present disclosure. The DC/DC converter according to the present embodiment is different from the DC/DC converter according to the first embodiment in that the former includes a semiconductor device 101 instead of the semiconductor device 100, and is similar to the DC/DC converter according to the first embodiment in other respects.

The semiconductor device 101 is different from the semiconductor device 100 in that the former includes a current detection circuit CS3 instead of the current detection circuits CS1 and CS2, and is similar to the semiconductor device 100 in other respects.

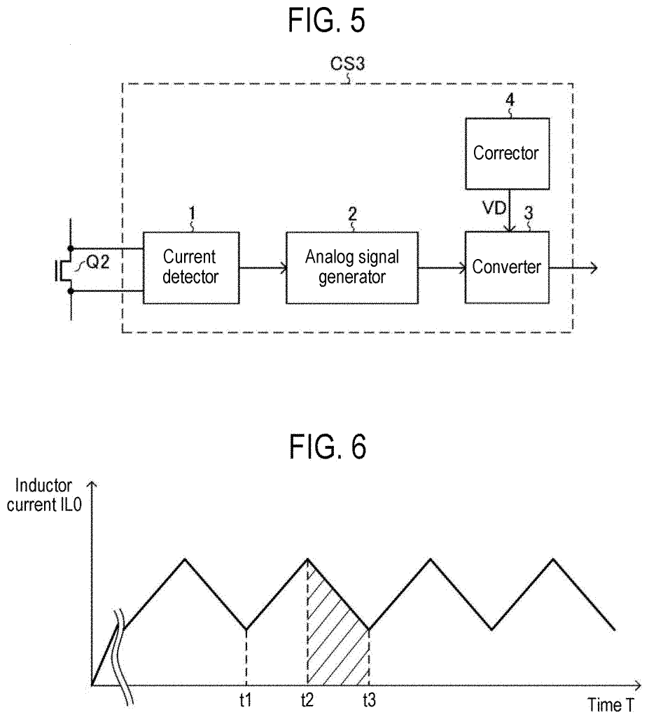

FIG. 5 is a diagram showing a first structure example of the current detection circuit CS3. The current detection circuit CS3 of the first structure example includes a current detector 1, an analog signal generator 2, a converter 3, and a corrector 4. The current detector 1 detects a current flowing through the second switch element Q2. The analog signal generator 2 generates an analog signal corresponding to the current detected by the current detector 1. The corrector 4 corrects a drive voltage VD according to the on-DUTY of the second switch element Q2. The analog signal generated by the analog signal generator 2 is input to the converter 3. The converter 3 converts the analog signal generated by the analog signal generator 2 to a digital signal corresponding to an integrated value of the analog signal, and outputs the digital signal.

FIG. 6 is a diagram showing an integration period of the integrated value of the analog signal. The second switch element Q2 is turned on during a period from t2 to t3. During this period, a current is detected by the current detection circuit CS3. By using a method of converting the integrated value of the analog signal in the period from t2 to t3 to a digital signal, as compared with a method of detecting a current at the middle point of a section in which the first switch element Q1 or the second switch element Q2 is turned on, it becomes easier to control a timing of current detection, thereby improving the accuracy of current detection. FIG. 6 shows a case where the on-DUTY of the second switch element Q2 is 50%, but the on-DUTY is not particularly limited to 50%.

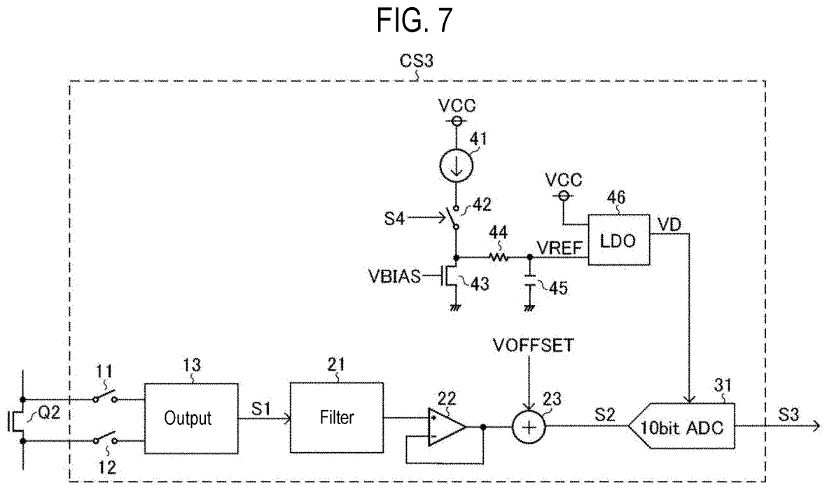

FIG. 7 is a diagram showing details of the first structure example of the current detection circuit CS3.

A switch 11, a switch 12, and an output 13 constitute the current detector 1 (see FIG. 5). A current detection signal S1 is output from the output 13 upon receiving an input between the drain and source of the second switch element Q2. The switches 11 and 12 are turned on only when the second switch element Q2 is turned on to suppress noise.

A filter 21, a buffer 22, and an adder 23 constitute the analog signal generator 2 (see FIG. 5). The analog signal generator 2 including the filter 21, the buffer 22, and the adder 23 generates an analog signal S2 from the current detection signal S1 output from the output 13.

An ADC (Analog-Digital Converter) 31 constitutes the converter 3 (see FIG. 5). In this structure example, the ADC 31 is a 10-bit ADC, but it may be an ADC other than 10-bit. The ADC 31 converts the analog signal S2 to a digital signal corresponding to an integrated value of the analog signal S2 by using a period from t2 to t3 as an integration period. The ADC 31 acquires information on t2 and t3 from the control circuit CT1. Unlike this structure example, the converter 3 (see FIG. 5) may include a filter that smoothes the analog signal S2, and an ADC that is driven by the drive voltage VD and converts the output of the filter to a digital signal. In this case as well, the converter 3 (see FIG. 5) converts the analog signal S2 to a digital signal corresponding to the integrated value of the analog signal S2 by using the period from t2 to t3 as the integration period. Further, unlike this structure example, the converter 3 (see FIG. 5) may include an ADC that is driven by the drive voltage VD and converts the analog signal S2 to a digital signal, and a digital operator that arithmetically processes the digital signal output from the ADC. The digital operator acquires information on t2 and t3 from the control circuit CT1 and integrates the digital signal by using the period from t2 to t3 as the integration period. In this case as well, the converter 3 (see FIG. 5) converts the analog signal S2 to a digital signal corresponding to the integrated value of the analog signal S2 by using the period from t2 to t3 as the integration period.

A constant current source 41, a switch 42, an NMOS transistor 43, a resistor 44, a capacitor 45, and a linear power supply circuit 46 constitute the corrector 4 (see FIG. 5). In this structure example, the linear power supply circuit 46 is an LDO (Low Dropout), but may be a linear power supply circuit other than the LDO. A constant bias voltage VBIAS is supplied to a gate of the NMOS transistor 43. Therefore, a resistance value between a source and a drain of the NMOS transistor 43 becomes substantially constant.

The switch 42 is turned on/off according to a signal S4. The signal S4 is output from the control circuit CT1. A rectangular wave voltage is generated at a connection node between the switch 42 and the NMOS transistor 43. This rectangular wave voltage is smoothed by the resistor 44 and the capacitor 45 to become a reference voltage VREF. The linear power supply circuit 46 converts the DC input voltage VCC to the drive voltage VD based on the reference voltage VREF. The ADC 31 is driven by the drive voltage VD output from the linear power supply circuit. The ADC 31 converts the analog signal S2 to a digital signal S3 and outputs the digital signal S3. The signal S4 turns on the switch 42 only at a timing when the second switch element Q2 is turned on. Therefore, a value of the reference voltage VREF used in the linear power supply circuit 46 varies according to the on-DUTY of the second switch element Q2. Therefore, a value of the drive voltage VD varies according to the on-DUTY of the second switch element Q2. Specifically, the value of the drive voltage VD is proportional to the on-DUTY of the second switch element Q2. As a result, even in a case where the on-DUTY of the second switch element Q2 is variable, when an average value of currents flowing through the inductor L0 is the same, the digital signal S3 having the same value is output from the ADC 31.

In the second embodiment, the number of current detection circuits may be reduced as compared with the first embodiment, thereby achieving cost reduction.

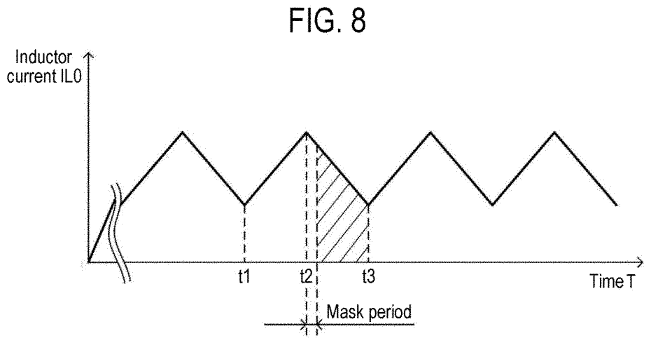

Although a mask period is not set in the above description, a mask period may be set to suppress an influence of noise. FIG. 8 is a diagram showing an integration period of an integrated value of an analog signal when a mask period is set. By turning on the switches 11 and 12 after a predetermined time has elapsed from the turn-on of the second switch element Q2, a mask period may be set in which the second switch element Q2 is turned on and a current detector does not detect a current flowing through the second switch element.

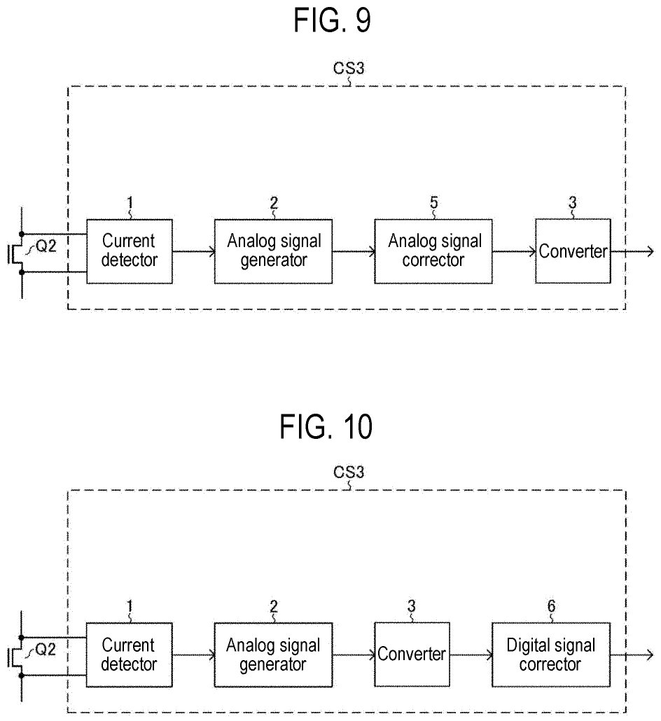

FIG. 9 is a diagram showing a second structure example of the current detection circuit CS3. The current detection circuit CS3 of the second structure example includes a current detector 1, an analog signal generator 2, a converter 3, and an analog signal corrector 5.

The current detector 1 detects a current flowing through the second switch element Q2. The analog signal generator 2 generates an analog signal corresponding to the current detected by the current detector 1. The analog signal corrector 5 corrects the analog signal generated by the analog signal generator 2 according to the on-DUTY of the second switch element Q2. The converter 3 converts an integrated value of the corrected analog signal output from the analog signal corrector 5 to a digital signal.

FIG. 10 is a diagram showing a third structure example of the current detection circuit CS3. The current detection circuit CS3 of the third structure example includes a current detector 1, an analog signal generator 2, a converter 3, and a digital signal corrector 6.

The current detector 1 detects a current flowing through the second switch element Q2. The analog signal generator 2 generates an analog signal corresponding to the current detected by the current detector 1. The converter 3 converts an integrated value of the analog signal generated by the analog signal generator 2 to a digital signal. The digital signal corrector 6 corrects the digital signal generated by the converter 3 according to the on-DUTY of the second switch element Q2.

The current detection circuit CS3 of the first structure example may not continuously correct an instantaneous value, unlike the current detection circuit CS3 of the second structure example, and also may not correct an AD-converted digital signal, unlike the current detection circuit CS3 of the third structure example. Therefore, a current detection accuracy of the current detection circuit CS3 of the first structure example may be higher than those of the current detection circuit CS3 of the second structure example and the current detection circuit CS3 of the third structure example.

### Third Embodiment

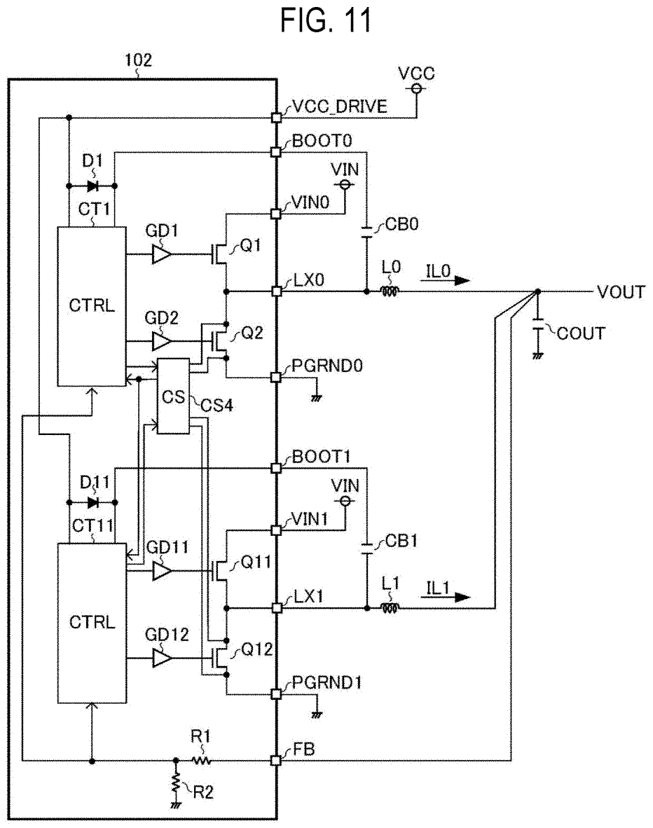

FIG. 11 is a diagram showing an overall structure of a DC/DC converter according to a third embodiment of the present disclosure. The DC/DC converter according to the present embodiment is a multiphase output DC/DC converter. The DC/DC converter according to the present embodiment is different from the DC/DC converter according to the second embodiment in that the former includes a semiconductor device 102 instead of the semiconductor device 101 and further includes an inductor L1 and a bootstrap capacitor CB1, and is similar to the DC/DC converter according to the second embodiment in other respects.

The semiconductor device 102 is different from the semiconductor device 100 in that the former includes a current detection circuit CS4 instead of the current detection circuit CS3, and further includes a terminal VIN1, a terminal LX1, a terminal BOOT1, a terminal PGRND1, a first switch element Q11, a second switch element Q12, a control circuit CT11, a driver GD11, a driver GD12, and a diode D11, and is similar to the semiconductor device 101 in other respects.

Since the terminal VIN1, the terminal LX1, the terminal BOOT1, the terminal PGRND1, the first switch element Q11, the second switch element Q12, the control circuit CT11, the driver GD11, the driver GD12, and the diode D11 are different only in phase from the terminal VIN0, the terminal LX0, the terminal BOOT0, the terminal PGRND0, the first switch element Q1, the second switch element Q2, the control circuit CT1, the driver GD1, the driver GD2, and the diode D1, detailed explanation thereof will be omitted herein.

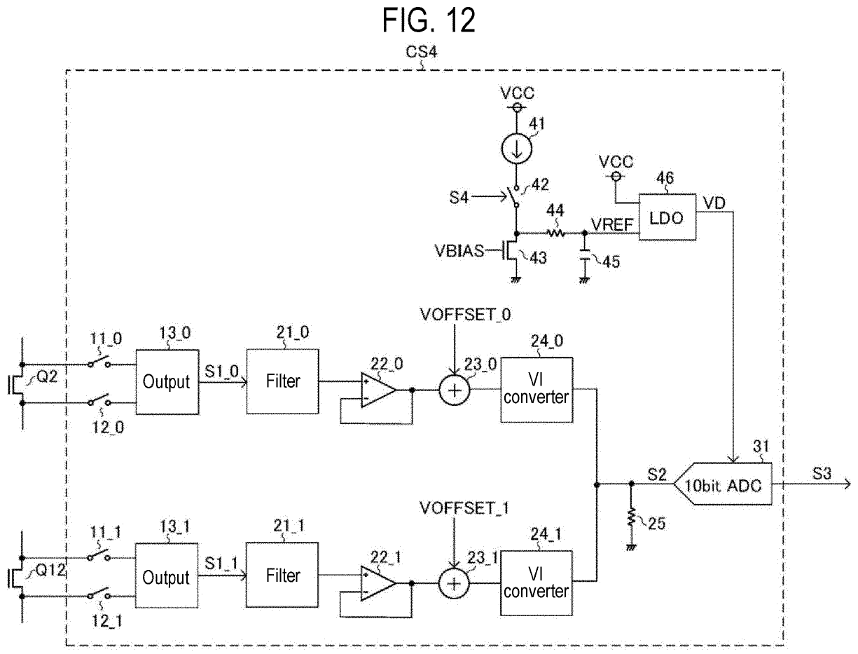

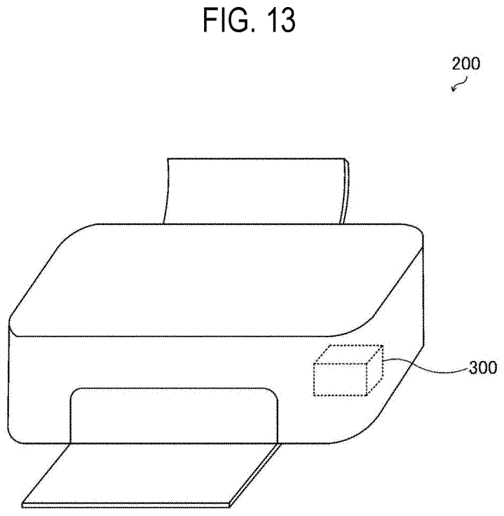

FIG. 12 is a diagram showing details of a structure example of the current detection circuit CS4. The current detection circuit CS4 shown in FIG. 12 is different from the current detection circuit CS3 shown in FIG. 7 in that the former includes a switch 11_0, a switch 12_0, an output 13_0, a filter 21_0, a buffer 22_0, an adder 23_0, a switch 11_1, a switch 12_1, an output 13_1, a filter 21_1, a buffer 22_1, and an adder 23_1, which are provided in two phases respectively, instead of the switch 11, the switch 12, the output 13, the filter 21, the buffer 22, and the adder 23 and further includes a VI converter 24_0, a VI converter 24_1, and a resistor 25, and is similar to the current detection circuit CS3 shown in FIG. 7 in other respects.

In the current detection circuit CS4 shown in FIG. 12, the analog signal S2 has a value corresponding to the sum of currents detected in both phases. Specifically, a voltage corresponding to the current flowing through the second switch Q2 is converted to a current by the VI converter 24_0, a voltage corresponding to the current flowing through the second switch Q12 is converted to a current by the VI converter 24_1, and a combined current of the current output from the VI converter 24_0 and the current output from the VI converter 24_1 is converted to a voltage by the resistor 25 to become the analog signal S2.

Also in the third embodiment, as in the second embodiment, it is possible to realize a current detection circuit that may reduce costs, easily control a timing of current detection, and obtain a high detection accuracy.

Although FIG. 12 shows a structure example of the current detection circuit CS4 in which the drive voltage of the converter 3 is corrected, the input or output of the converter 3 may be corrected.

### <Applications>

FIG. 13 is a view showing an electric apparatus. The electric apparatus 200 shown in FIG. 13 is a printer. As a power supply 300 built into the electric apparatus 200, the DC/DC converter described above may be used. The DC/DC converter described above may also be installed in electric apparatuses other than the printer.

### <Others>

In addition to the above-described embodiments, the structure of the present disclosure may be modified in various ways without departing from the gist of the disclosure. The embodiments described above are exemplary in all respects and are not restrictive, and the technical scope of the present disclosure is defined by the claims rather than the description of the embodiments and should be understood to include all changes that fall within the meaning and scope equivalent to the claims.

For example, in the second and third embodiments, the current detection circuit that detects the current flowing through the lower switch is used, but a current detection circuit that detects the current flowing through the upper switch may be used. However, unlike the current detection circuit that detects the current that flows through the upper switch, the current detection circuit that detects the current that flows through the lower switch may use low-breakdown-voltage elements, which may reduce costs.

The current detection circuit (CS3) described above includes a feature that it includes: at least one current detector (1) configured to detect a current flowing through a second switch element of at least one switching output stage configured to connect a first switch element (Q1) and the second switch element (Q2) in series; an analog signal generator (2) configured to generate an analog signal corresponding to the current detected by the at least one current detector; a converter (3) configured to receive the analog signal, convert the analog signal to a digital signal corresponding to an integrated value of the analog signal, and output the digital signal; and a corrector (4) configured to correct any one of a drive voltage, an input, and an output of the converter according to the on-DUTY of the second switch element (first feature).

The current detection circuit of the first feature may reduce costs, easily control a timing of current detection, and obtain a high detection accuracy.

The current detection circuit of the first feature may include a feature that the second switch element is turned on during an integration period of the integrated value (second feature).

The current detection circuit of the second feature may eliminate a wasteful integration period (an integration period when the first switch element is turned on).

The current detection circuit of the second feature may include a feature that a mask period is set in which the second switch element is turned on and the at least one current detector does not detect the current flowing through the second switch element, and the corrector is configured to correct any one of the drive voltage, the input, and the output according to the on-DUTY and the mask period (third feature).

The current detection circuit of the third feature may suppress an influence of noise.

The current detection circuit of any one of the first to third features may include a feature that a first end of the first switch element is configured such that e a first voltage is applied to the first end of the first switch element, a second end of the first switch element is connected to a first end of the second switch element, a second end of the second switch element is configured such that a second voltage is applied to the second end of the second switch element, and the second voltage is less than the first voltage (fourth feature).

The current detection circuit of the fourth feature may use low-breakdown-voltage elements, thereby further reducing the cost.

The current detection circuit of any one of the first to fourth features may include a feature that the corrector is configured to correct the drive voltage (fifth feature).

The current detection circuit of the fifth feature may further improve the detection accuracy.

The current detection circuit of the fifth feature may include a feature that the corrector includes a linear power supply circuit configured to generate the drive voltage, and a value of a reference voltage used in the linear power supply circuit varies according to the on-DUTY (sixth feature).

The current detection circuit of the sixth feature may realize the corrector with a simple circuit structure.

The DC/DC converter described above includes a feature that it includes: the current detection circuit any one of the first to sixth features; and the at least one switching output stage configured to connect a first switch element and a second switch element in series (seventh feature).

In the DC/DC converter of the seventh feature, the current detection circuit may reduce costs, easily control a timing of current detection, and obtain the high detection accuracy.

The DC/DC converter of the seventh feature may include a feature that the at least one switching output stage includes a plurality of switching output stages, the at least one current detector includes a plurality of current detectors, the current detection circuit includes the plurality of current detectors such that the plurality of current detectors correspond to the plurality of switching output stages, respectively, and the analog signal generator is configured to generate the analog signal according to a sum of currents detected by the plurality of current detectors, respectively (eighth feature).

The DC/DC converter of the eighth feature enables multiphase output.

The electric apparatus described above includes a feature that it includes the DC/DC converter of the seventh or eighth feature (ninth feature).

In the electric apparatus of the ninth feature, the current detection circuit may reduce costs, easily control a timing of current detection, and obtain a high detection accuracy.

According to the present disclosure in some embodiments, it is possible to provide a current detection circuit that may reduce costs, easily control a timing of current detection, and obtain a high detection accuracy.

While certain embodiments have been described, these embodiments have been presented by way of example only, and are not intended to limit the scope of the disclosures. Indeed, the embodiments described herein may be embodied in a variety of other forms. Furthermore, various omissions, substitutions and changes in the form of the embodiments described herein may be made without departing from the spirit of the disclosures. The accompanying claims and their equivalents are intended to cover such forms or modifications as would fall within the scope and spirit of the disclosures.

What is claimed is:

1. A current detection circuit comprising:
at least one current detector configured to detect a current flowing through a second switch element of at least one switching output stage configured to connect a first switch element and the second switch element in series;
an analog signal generator configured to generate an analog signal corresponding to the current detected by the at least one current detector;
a converter configured to receive the analog signal, convert the analog signal to a digital signal corresponding to an integrated value of the analog signal, and output the digital signal; and
a corrector configured to correct any one of a drive voltage, an input, and an output of the converter according to an on-DUTY of the second switch element.

2. The current detection circuit of claim 1, wherein the second switch element is turned on during an integration period of the integrated value.

3. The current detection circuit of claim 2, wherein a mask period is set in which the second switch element is turned on and the at least one current detector does not detect the current flowing through the second switch element, and
wherein the corrector is configured to correct any one of the drive voltage, the input, and the output according to the on-DUTY and the mask period.

4. The current detection circuit of claim 1, wherein a first end of the first switch element is configured such that a first voltage is applied to the first end of the first switch element,
wherein a second end of the first switch element is connected to a first end of the second switch element,
wherein a second end of the second switch element is configured such that a second voltage is applied to the second end of the second switch element, and
wherein the second voltage is less than the first voltage.

5. The current detection circuit of claim 1, wherein the corrector is configured to correct the drive voltage.

6. The current detection circuit of claim 5, wherein the corrector includes a linear power supply circuit configured to generate the drive voltage, and
wherein a value of a reference voltage used in the linear power supply circuit varies according to the on-DUTY.

7. A DC/DC converter comprising:
the current detection circuit of claim 1; and
the at least one switching output stage configured to connect the first switch element and the second switch element in series.

8. The DC/DC converter of claim 7, wherein the at least one switching output stage includes a plurality of switching output stages,
wherein the at least one current detector includes a plurality of current detectors,
wherein the current detection circuit includes the plurality of current detectors such that the plurality of current detectors correspond to the plurality of switching output stages, respectively, and
wherein the analog signal generator is configured to generate the analog signal according to a sum of currents detected by the plurality of current detectors, respectively.

9. An electric apparatus comprising: the DC/DC converter of claim 7.
